(19) United States
(12) Patent Application Publication
(10) Pub. No.: US 2007/0262018 A1
(43) Pub. Date: Nov. 15, 2007

(54) Method and product for protecting the residential and commercial aquatic environment

(76) Inventors: Michael Richter, Oceanside, NY (US); Douglas A. Dent, New Hope, PA (US)

Correspondence Address: DEBORAH A. GRIM, 6807 DUKE DRIVE, ALEXANDRIA, VA, 22307, US

(21) Appl. No.: 11/430,209

(22) Filed: May 9, 2006

(51) Int. Cl. C02F 3/00

(52) U.S. Cl. 210/610; 210/611; 210/615

(57) ABSTRACT

A method for improving biological reaction within contained water including the use of liners. The inventive concept is designed for treating a body of water having impurities therein. The product consists of a biological formulation on surface media designed to release microorganisms to the containment system to assure a rapid removal of waste material. The liner material microorganisms are attached via microbial charge to the liner surface to the colonized liner material that is used in any liquid or moist waste holding or containment systems.

### FIELD OF THE INVENTION

The invention is directed to direct fermentation biotechnologies for developing, formulating microbial technologies and products designed for the residential and commercial aquatic environment, such as ponds and aquarium segments and applications for water clarification and purification.

### BACKGROUND OF THE INVENTION

The inventive discoveries are designed, specifically, to speed a biological removal of waste matter from the aquatic environment and to promote a cleaner aquatic environment to support a healthy marine life. The inventive concepts are directed to a novel blending of pond and aquatic liner material in combination with attached microorganisms.

There are currently many biologically based products and supporting technologies that are designed to assist and speed the necessary biological oxidation processes in aquatic waters. Their concept is based on the fact that bacteria are responsible for the removal of all waste organic matter from the environment; as well as, pond, fish ponds, artificial ponds and aquarium waters. Existing microbial technology combines the use of modern microbiology that selects microorganisms that have higher rates of biological oxidation of waste organic matter reduce organic pollutants to better support aquatic life forms. Water quality is negatively effected by the increased organic loading associated with closed aquatic features that contain large numbers of marine life, fish for example, as these factors contribute to water pollution via the high levels of organic waste matter.

Water pollution comes from a variety of marine species confined in a specific volume of water (closed system); as well as, the continued growth of fish, the addition of their off-springs (all aquatic species), their waste, excessive feeding of the fish, and air born pollutants. These factors all contribute to a rapid water pollution as the organic loading to the confined body of water is greater than the natural biological oxidation of waste organic matter by the indigenous microorganism. These factors lead to reduced water quality and the potential loss of aquatic life from pollution.

### BRIEF DESCRIPTION OF THE INVENTION

The inventive concept provides for a pre-inoculation of all types of pond liners with a select group of spore forming waste degrading microorganisms. The microbial inoculated pond liners are pre coated with a consortium of spore forming microorganisms that are capable of remaining inactive in a dormant state for an extended period of time. Following the addition of water containing waste organic matter the attached microorganisms on the pre coated liner surface will germinate, become active, and respond to the organic matter. The culture activation process takes place following the treated liners placement in any aquatic environment that contains waste organic matter, such as ponds, lakes, hatcheries or water storage basins. Once the microbial pre treated liners are exposed to water containing organic matter, the microorganisms will germinate, grow and form new microbial colonies via cell division. The existing cultures and new microbes will form additional microbial attachment to the liner surface and will absorb and break down organic matter improving the rate of biological oxidation by way of the attached bio-film formation on the liner surface. The biological process will enhance and speed the overall removal of waste organic matter on the liner surface, and within the developing bio-film, and within the bulk liquid of the contained water.

The pre inoculated liner, such as rubber, polyethylene and other related liner materials will increase the microbial functions specific to achieving a more rapid biological oxidation of organic matter within the entire pond water feature and other related biological water clarification systems and equipment that use liners to retain water.

### DETAILED DESCRIPTION OF THE INVENTION

As mentioned above, the inventive concept is based on pre-inoculating or pre-colonizing certain types of water retention liners with select strains of bacteria. The benefits of pre-colonizing liners are to speed the biological removal of organic matter within the contained water and aquatic system. The inventive concept reduces the time for biological function to occur; and improve the rate of biological removal efficiency. Examples of such pre-colonized liner follow below:

Pond Liner Material:

Pond liners provide a significant surface area for biological filtration and organic removal to occur. They are excellent for oxygen and gas exchange, this will be explained below.

Pre-Colonization by Bacteria:

Bacteria are a substance of numerous microscopic, spherical rod-shaped or spiral organisms, various species of which are concerned in fermentation and putrefaction. The putrefaction of water bodies is the inventive concept of this specification.

### Description of Bio-Films

Bio-films consist of two major components (1) microorganisms that are embedded in (2) a matrix of extra cellular polymer substance (ESP) of microbial origin. Such bio-films result from the initial absorption of microorganisms to solid substrata followed by growth of the microorganisms, ESP production, and the capture or entrapment of other microbial cells from the aqueous phase.

In order to emphasize the importance of bio-films in wastewater processes, it should be noted that bio-films may contain as many as 10/16 cells/m-3 (10-13 cells liter), a cell concentration considerably higher than suspended cultures in water. This high rate biological concentration, oxidation reaction, combined with increased microbial surface area reaction of pre coated microorganisms will increase an organic removal effect significantly. This invention is designed to improve bio-film development on liner surfaces, and to speed the rate of culture growth and the effectiveness for organic removal on liner surfaces and the bulk liquid during start up and during continued waste loading to the contained water.

Pre-colonized liners will assist in a more rapid and effective bio-film development via microbial cells and division following the introduction of organic matter by way of (1) transport of cell to the media (substratum), (2) absorption of cells to the media, (3) growth and metabolic processes within the bio-film (EPS production). The bacteria cells released from the discovery pre-colonized liner material will first form initial charge attachment to the media, grow and cell divide, new microbes will form followed by the development of gel materics (EPS) and the formation of additional bio-film and combined microorganisms will absorb and break down organic matter oxidation via the active bio-film formation on the liner surface providing an overall increase in the removal rate of waste organic matter.

The inoculated liner will aid in seeding the contained water and other related surface materials increasing the overall rate of biological oxidation of organic matter within the containment system (pond, lake or waste holding pit) resulting in a more rapid biological process of water clarification, i.e. biological organic removal.

### DETAILED DESCRIPTION OF THE INVENTION

As mentioned above, the inventive concept is based on pre attachment of liner material with microorganisms to speed bio-film development containing waste degrading heterotrophic microorganisms.

Filter Media:

Rubber and all other types of filter media.

Bacteria:

1. As above to include such strains as;
2. Bacillus lichenformis
3. Bacillus megaterium
4. Bacillus polymyxa
5. Bacillus cerculans
6. Bacillus subtilis
7. Paenibaciilus polymxa
8. Rodopseudomonas
9. Rhodospirillum
10. Thiobacillus novellas
11. Thiobacillus thiooxidans
12. Thiobacillus denitrificans
13. Pseudomonas fluorescens
14. Alcaligenes denitrificans
16. Flavobacterium aquatile
16. Flavobacterium oceanosedimentum
17. Nitrobacter winogradskyi
18. Nitrosomonas europaea
19. Serratia liquifaciens

The above cultures, 1 through 7; as well as, other Bacillus spore microbes may be used to inoculate various liner surfaces providing long term shelf life in an inactive state. The attached spore microbes will become active following the introduction of waste organic matter to the liner containment system. The cultures listed 8 through 19 indicate various vegetative microorganisms that can be used for short term attachment prior to use. The attached spore based microorganisms on the liner surface will germinate following the addition of liquid and organic waste matter, become active and release microorganisms to the contained water within the containment system (pond, lake or pit), as well as, continue to increase essential bio-film on the liner surface to enhance biological oxidation of waste organic matter from the aquatic feature. The inventive concept reduces the time for normal biological reactions to occur on liner surfaces and in the bulk liquid within the contained waters.

### Method of use of the Liner Material

The pond liner will be pre coated with a liquid suspension of spore forming microorganisms. The microorganisms will form an attachment to the liner surface via charge relationship, and then be allowed time to dry on the liner surfaces prior to packaging. Following the liner's introduction to a holding system and the addition of water that contains waste organic matter, the microorganisms will become active, germinate and begin to produce additional microbial colonies. The released microorganisms will seed the bulk liquid and form additional microbial attachments to the liner surface via a charge followed by bio-film continued formation on the liner surface where there is organic matter to support biological oxidation (organic removal). The biological treated liner discovery will aid in establishing necessary biological organic removal on liner surfaces and within the contained water system.

What we claim is:

1. A biological method designed to speed the overall biological oxidation removal rate of organic waste matter within any waste water liquid containment system, said method comprising the steps of using a liner within said containment system to establish a lined aquatic environment, said liner having a surface, pre-coating said surface with attached microorganisms that will germinate and grow to establish necessary bio films on said liner surface, contacting said surface with liquid waste containing organic matter, whereby said liner organisms will then grow, multiply and seed said water with additional microorganisms to thereby increase the biological removal efficiency of the waste water contained within the lined aquatic environment, wherein said microorganisms are applied to said liner in a dry biological formulation.

2. The method of claim 1, wherein said microorganisms are applied to said liner in a liquid biological formulation.

3. (canceled)

4. The method of claim 1, wherein said liner is a rubber material.

5. The method of claim 1, wherein said liner is a polyethylene material.

6. The method of claim 1, wherein said microorganisms are selected from the group of microorganisms consisting of:
Bacillus lichenformis,
Bacillus magaterium
Bacillus polymyxa
Bacillus cerculans
Bacillus subtilis
Paenibacillus polymyxa
Rodopseudomonas
Rhodospirillum
Thiobacillus novellas
Thiobacillus thiooxidans
Thiobacillus denitrificans
Pseudomonas flouresecens
Alcaligones denitrificans
Flavobactrium aquatile
Flavobactrium oceanosedimentum
Nitrobacter winogradskyi
Nitrosomonas europaea
Serratia liquifaciens.

7. A method of pre colonizing a water containment area having impurities therein including the steps of attaching microbial spore forming microorganisms to a liner to be placed within said containment area by pre coating said liner, allowing said pre coated liner to dry and packaging, thereafter introducing said pre coated liner from said package into said water containment area that contains waste organic matter, thereby activating said microorganisms to germinate and begin to produce additional microbial colonies.
